(19) United States
(12) Patent Application Publication
(10) Pub. No.: US 2016/0316020 A1
(43) Pub. Date: Oct. 27, 2016

(54) WEB PAGE INFORMATION PRESENTATION METHOD AND SYSTEM

(71) Applicant: TENCENT TECHNOLOGY (SHENZHEN) COMPANY LIMITED, Shenzhen (CN)

(72) Inventor: Gang Wang, Shenzhen (CN)

(21) Appl. No.: 15/202,788

(22) Filed: Jul. 6, 2016

Related U.S. Application Data
(63) Continuation of application No. PCT/CN2015/082113, filed on Jun. 23, 2015.

(30) Foreign Application Priority Data
Jun. 24, 2014 (CN) 201410290253.7

(51) Int. Cl. H04L 29/08; H04L 29/06

(52) U.S. Cl. CPC H04L 67/1097; H04L 67/02; H04L 67/42

(57) ABSTRACT

A web page information presentation method includes steps of: receiving a web page access request, the web page access request being a web page access request generated according to a web page link in a dialog box of a client; determining web page content according to the web page access request, and assembling the web page content according to prestored layout templates to obtain laid out presentation data; and returning the presentation data to the client for presentation.

### CROSS-REFERENCE TO RELATED APPLICATIONS

This is a continuation application of International Patent Application No. PCT/CN2015/082113, filed on Jun. 23, 2015, which claims the priority benefit of Chinese Patent Application No. 201410290253.7, filed on Jun. 24, 2014, the contents of which are incorporated by reference herein in their entirety for all purposes.

### FIELD OF THE INVENTION

The present disclosure relates to computer technologies, and in particular, to a web page information presentation method and system.

### BACKGROUND OF THE INVENTION

With the development of the Internet, instant messaging (IM) is also rapidly developed. The IM is a service for instant exchange of messages based on the Internet. Nowadays, increasingly more people implement instant communication by means of the IM. When a user sends or receives a uniform resource locator (URL, which may also be referred to as a web page link) in a communication dialog box, in order to view content of the link faster and more conveniently, web page information such as a title and a brief introduction of a web page corresponding to the URL is always acquired, and the web page information is presented in the dialog box in a graphic manner.

In order to present the web page information of the web page link in the graphic manner, in a traditional technology, the web page link is determined by using a client and is converted into a corresponding protocol field. A Client/Server (C/S) pulls, from a server in a binary manner, corresponding fields from a service platform by using a communications protocol or the Hypertext Transfer Protocol (HTTP); the client parses the pulled fields, and finally assemblies the fields into a visual interface and presents the visual interface in the dialog box.

When the traditional technology is used, both the client and the service platform perform corresponding development and processing. For example, the client needs to parse a protocol, analyze fields, and assemble the fields into a visual interface before presenting an interface, which greatly reduces efficiency of processing the web page information in a presentation process.

### SUMMARY

Based on this, it is necessary to provide a web page information presentation method and system for a problem of low processing efficiency of web page information in a presentation process.

A web page information presentation method includes steps of:

receiving a web page access request, the web page access request being a web page access request generated according to a web page link in a dialog box of a client;

determining web page content according to the web page access request, and assembling the web page content according to prestored layout templates to obtain laid out presentation data; and

returning the presentation data to the client for presentation.

A web page information presentation system includes:

a web page access request receiving module, configured to receive a web page access request, the web page access request being a web page access request generated according to a web page link in a dialog box of a client;

a data determining module, configured to determine web page content according to the web page access request, and assemble the web page content according to prestored layout templates to obtain laid out presentation data; and

a presentation module, configured to return the presentation data to the client for presentation.

According to the foregoing web page information presentation method and system, a web page access request of a client is received; web page content is determined according to the web page access request; the web page content is assembled according to prestored layout templates, so as to obtain laid out presentation data; and then, the presentation data is returned to the client and is directly presented in the client, so as to avoid a processing process of assembling fields by the client and saving a processing time of the client, thereby accelerating efficiency of processing the web page information in a presentation process.

A web page information presentation method includes steps of:

acquiring a web page link in a dialog box of a client, and initiating a web page access request to a service platform according to the web page link;

receiving laid out presentation data returned by the service platform, the presentation data including assembled web page content corresponding to the web page access request; and

presenting the presentation data in the dialog box.

A web page information presentation system includes:

a web page link acquiring module, configured to acquire a web page link in a dialog box of a client;

a sending module, configured to initiate a web page access request to a service platform according to the web page link;

a first data receiving module, configured to receive laid out presentation data returned by the service platform, the presentation data including assembled web page content corresponding to the web page access request; and

a first presentation module, configured to present the presentation data in the dialog box.

According to the foregoing web page information presentation method and system, a web page link in a dialog box of a client is acquired; a web page access request is initiated to a service platform according to the web page link; then, laid out presentation data returned by the service platform is received; and the presentation data is directly presented in the dialog box, so as to avoid a processing process of assembling fields by the client and saving a processing time of the client, thereby accelerating efficiency of processing the web page information in a presentation process.

### BRIEF DESCRIPTION OF THE DRAWINGS

FIG. 1 is a schematic flowchart of a web page information presentation method in an embodiment of the present invention;

FIG. 2 is a schematic flowchart of a web page information presentation method in another embodiment of the present invention;

FIG. 3 is a schematic architectural diagram of implementation of an application example;

FIG. 4 is a schematic flowchart of a web page information presentation method in an application example of the present disclosure;

FIG. 5 is a schematic flowchart of a web page information presentation method in another application example of the present disclosure;

FIG. 6 is a schematic structural diagram of a web page information presentation system in an embodiment of the present invention;

FIG. 7 is a schematic structural diagram of a web page information presentation system in another embodiment of the present invention;

FIG. 8 is a schematic structural diagram of a web page information presentation system in an application example of the present disclosure; and

FIG. 9 is a partial structural block diagram of a terminal provided based on a solution of the present disclosure.

### DESCRIPTION OF EMBODIMENTS

The following describes embodiments of a web page information presentation method and system of the present disclosure in detail.

The method as disclosed as following may be implemented by any appropriate terminal having one or more processors and a memory. The computing device, used herein, may refer to any appropriate device with certain computing capabilities, such as a personal computer (PC), a work station computer, a hand-held computing device (tablet), a mobile terminal (a terminal device or a smart phone), a server, a network server, a smart terminal, or any other user-side or server-side computing device. The memory includes a storage medium, which may further include memory modules, for example, a Read-Only Memory (ROM), a Random Access Memory (RAM), and flash memory modules, and mass storages, for example, a CD-ROM, a U-disk, a removable hard disk, and the like, which are all non-transitory storage mediums. The storage medium may store computer programs for implementing various processes, when executed by the processors.

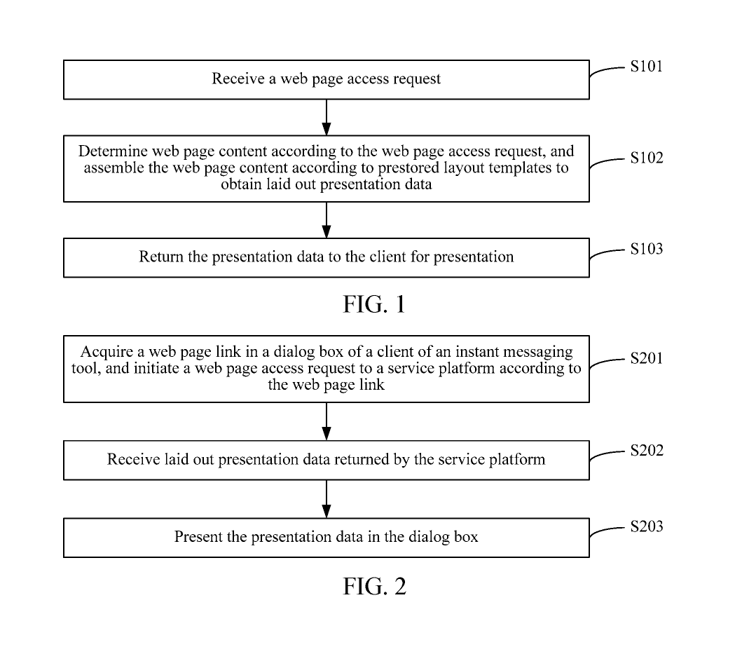

FIG. 1 is a schematic flowchart of a web page information presentation method in an embodiment of the present invention. The method includes steps of:

Step S101: Receive a web page access request, the web page access request being a web page access request generated according to a web page link in a dialog box of a client.

An IM tool may be a service for instant exchange of messages based on the Internet, such as QQ, WeChat, or Fetion. The dialog box may be a window used for communication, such as a chat window. When a web page link URL is sent or received in the dialog box of the client, a web page access request may be generated. The web page access request herein may be a received web page access request sent by the client, and may also be a web page access request sent by the client by using an interconnecting background.

Step S102: Determine web page content according to the web page access request, and assemble the web page content according to prestored layout templates to obtain laid out presentation data.

In this step, the web page content corresponding to the web page link may be obtained according to the web page access request, and then the web page content is assembled according to the prestored layout templates. For example, the corresponding web page content may be acquired according to a label name in the layout template, and the web page content is written under the corresponding label name, so as to obtain the laid out presentation data. The presentation data is data that needs to be presented in the dialog box, and the presented data may be data in a graphic manner and may also be eXtensible Markup Language (xml) data.

Step S103: Return the presentation data to the client for presentation.

The presentation data is sent to the client, and the presentation data is directly presented in the client.

In this embodiment, a web page access request of a client is received; web page content is determined according to the web page access request; the web page content is assembled according to prestored layout templates, so as to obtain laid out presentation data; and then, the presentation data is returned to the client and is directly presented in the client, so as to avoid a processing process of assembling fields by the client and saving a processing time of the client, thereby accelerating efficiency of processing the web page information in a presentation process.

Step S101, step S102, and step S103 can be implemented in a service platform. The service platform is a platform corresponding to the web page link, and may be, for example, an e-commerce platform.

In an embodiment, sometimes, the layout templates need to be changed to present interfaces of different layouts in the dialog box. That is, the web page access request may further include a layout selection instruction; and before step S102, the method may further include:

finding a corresponding layout template from the prestored layout templates according to the layout selection instruction, where the number of the prestored layout templates is at least two.

In this embodiment, multiple layout templates are prestored, and one of the layout templates may be set as a default layout template. When no layout selection instruction is received, the default layout template may be used as the layout template for assembly. When the layout selection instruction is received, the corresponding layout template may be selected from the multiple layout templates.

By using the solution in this embodiment, when the template is modified, redevelopment made by the client is avoided. Instead, different layout templates are selected directly according to the layout selection instruction, thereby implementing modification of the layout templates, lowering a development burden of the client, and improving development efficiency. Meanwhile, the solution used flexibly, and a presentation interface in the dialog box can be modified at any time.

FIG. 2 is a schematic flowchart of a web page information presentation method in another embodiment of the present invention. The method includes steps of:

Step S201: Acquire a web page link in a dialog box of a client, and initiate a web page access request to a service platform according to the web page link.

A means of acquiring the web page link may be detecting whether the dialog box of the client receives or sends the web page link; and if yes, generating the web page access request according to the web page link; and the web page access request may be initiated to the service platform.

In an embodiment, the web page access request may be filtered. That is, before the step of initiating a web page access request to a service platform according to the web page link, the method further includes:

detecting whether the web page link is a web page link in a white list, where the white list records a web page link that needs to be visually presented; and

performing, if yes, the step of initiating a web page access request to a service platform according to the web page link.

This step, as a step of filtering, is deleting a web page link that is not in the white list and not performing a subsequent process; and generating a web page access request only for a web page link in the white list and sending the web page access request to the service platform, thereby improving processing efficiency.

In an embodiment, the web page access request may be further encrypted, so as to ensure security of the web page access request.

Step S202: Receive laid out presentation data returned by the service platform, the presentation data including assembled web page content corresponding to the web page access request.

The presentation data mentioned above includes data obtained after the web page content to be presented is assembled, that is, laid out web page content. For example, the web page content may be assembled according to the prestored layout templates, so as to obtain the presentation data.

Step S203: Present the presentation data in the dialog box.

After the presentation data is obtained, because the presentation data is the laid out web page content, the presentation data can be directly presented in the dialog box.

In this embodiment, a web page link is acquired; a web page access request is initiated to a service platform according to the web page link; then, laid out presentation data returned by the service platform is received; and the presentation data is directly presented in the dialog box, so as to avoid a processing process of assembling fields by the client and saving a processing time of the client, thereby accelerating efficiency of processing the web page information in a presentation process.

In an embodiment, step S203 may specifically include:

A1: Acquire a layout template in the presentation data; create a presentation control of the client according to the layout template; and set a name of the presentation control to be consistent with a label name in the layout template, where the layout template is a template for assembling the web page content, and the label name is a name corresponding to the web page content in the layout template.

The acquired presentation data may be data obtained by assembling the web page content according to the layout template. Therefore, the layout template may be acquired from the presentation data. The layout template records the label name and the web page content corresponding to the name, so that the presentation control of the client can be created according to the layout template.

A2: Acquire an interface pointer corresponding to the name of the presentation control by using the label name in the layout template; and write the web page content corresponding to the label name into the presentation control by using the interface pointer.

This step is a process of filling the presentation control with data.

A3: Present the web page content in the dialog box according to the presentation control. Therefore, a process of presenting the laid out presentation data is implemented.

In an embodiment, the client may further process unlaid out data. That is, the web page information presentation method in the present disclosure may further include:

receiving the unlaid out data returned by the service platform; and

parsing the unlaid out data, assembling the unlaid out data, and presenting the assembled data in the dialog box.

In this embodiment, the client can not only present the laid out presentation data, but also can parse and assemble the unlaid out data to present the data in the dialog box.

Moreover, the service platform may be further determined, and different processing is selected according to different determining results. That is, before the step of initiating a web page access request to a service platform according to the web page link, the method may further include:

determining whether the service platform corresponding to the web page link is a service platform in the white list, where the white list records a service platform that has an assembly function; and

performing, if yes, the step of initiating a web page access request to a service platform according to the web page link; or

pulling corresponding fields (the unlaid out data) from the service platform by using the CS protocol or the HTTP protocol, parsing the fields, assembling the parsed fields into presentation data, and presenting the presentation data if not.

In this embodiment, the service platform is determined; and for a service platform that has the assembly function, a solution of performing assembly in the service platform is used; and for a service platform that does not have the assembly function, a solution of performing assembly in the client is used.

Technical features in the foregoing implementation manners can be arbitrarily combined, as long as there are no conflicts or contradictions in combination of the features. However, due to a limited space, the features are not described one by one. Therefore, any combination of the technical features in the foregoing implementation manners also falls within the scope disclosed by the specification.

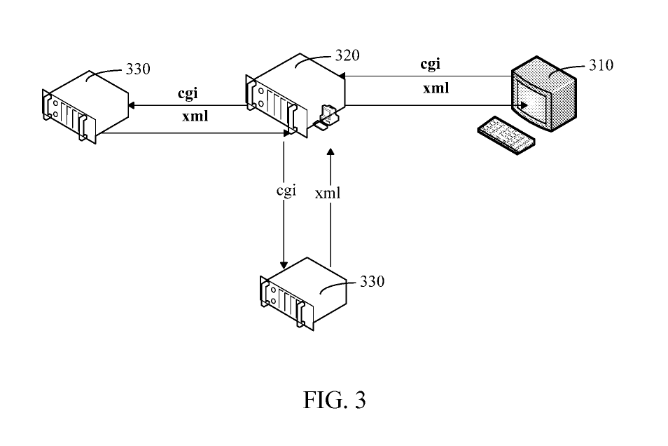

The present disclosure further provides an application example. FIG. 3 is a schematic architectural diagram of implementation of the application example. The application example includes: a client 310, an interconnecting platform 320, and a service platform 330. The client 310 is separately connected to the service platform 330 by using the interconnecting platform 320. There may be multiple service platforms, and the multiple service platforms are shown in the figure by using a numeral 330.

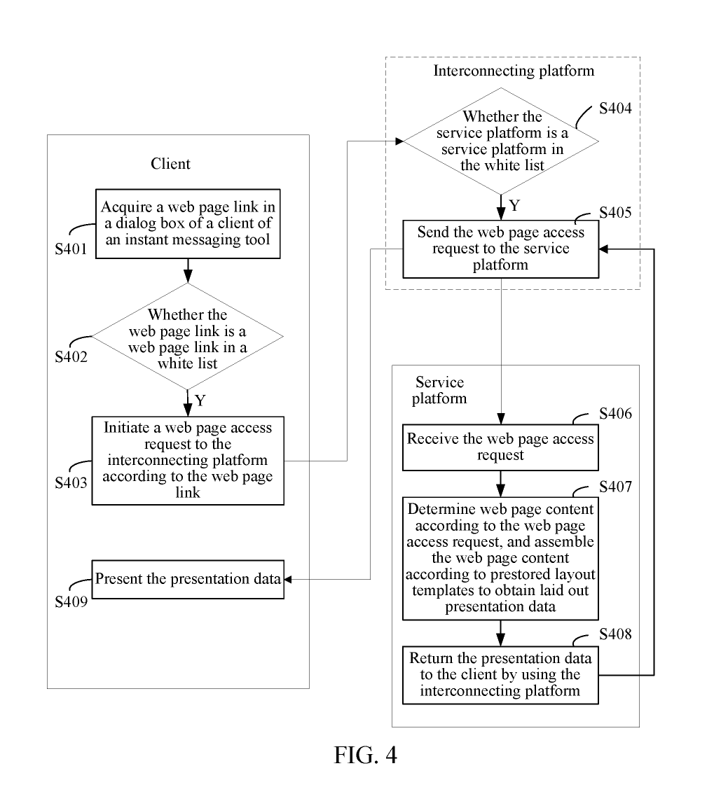

FIG. 4 is a schematic flowchart of a web page information presentation method in an application example of the present disclosure. The method includes:

Steps Performed on a Client:

Step S401: Acquire a web page link in a dialog box of the client.

Step S402: Determine whether the web page link is a web page link in a white list, where the white list records a web page link that needs to be visually presented.

Step S403: Initiate a web page access request to an interconnecting platform according to the web page link if yes.

Steps Performed on the Interconnecting Platform:

Step S404: Determine whether a service platform corresponding to the web page access request is a service platform in the white list, where the white list records a service platform that has an assembly function.

Step S405: Send the web page access request to the service platform if yes.

Steps Performed on the Service Platform:

Step S406: Receive the web page access request.

Step S407: Determine web page content according to the web page access request, and assemble the web page content according to prestored layout templates to obtain laid out presentation data.

Step S408: Return the presentation data to the client by using the interconnecting platform.

Steps Performed on the Client:

Step S409: Present the presentation data.

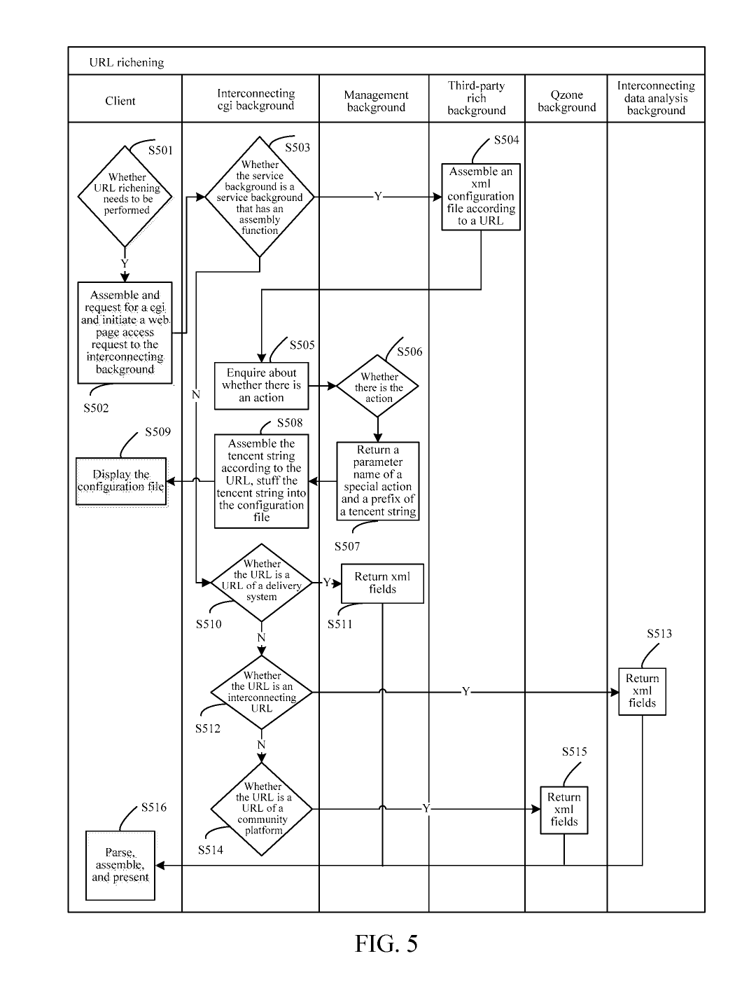

The present disclosure further provides another application example. FIG. 5 is a schematic flowchart of a web page information presentation method in another application example of the present disclosure. The method includes:

Step S501: After receiving a URL, a client views whether URL richening (that is, whether visualization presentation is needed) needs to be performed in a local white list.

Step S502: Assemble and request for a common gateway interface (cgi) and initiate a web page access request to an interconnecting background if yes.

Step S503: An interconnecting cgi background determines whether a service background is a service background (for example, a deep service partner) that has an assembly function, and perform step S504 if yes; or perform S510 if not.

Step S504: Determine web page content according to the web page access request in a third-party rich service background, assemble the web page content according to prestored layout templates to obtain a laid out xml configuration file (presentation data), and return the xml configuration file to the interconnecting background.

Step S505: The interconnecting background receives a richened xml configuration file, and enquires a management background about whether there is a special action.

Step S506: Determine, in the management background, whether there is the special action.

Step S507: Return, in the management background, a parameter name of the special action and a prefix of a tencent string to the interconnecting background if there is the special action.

Step S508: Assemble the tencent string according to the URL, stuff the tencent string into the configuration file, send the configuration file to the client, and perform step S509.

Step S509: The client directly displays the configuration file when receiving the configuration file.

Step S510: Determine whether the web page link in the web page access request is a web page link URL of a delivery system; and perform step S511 if yes; or perform step S512 if not.

Step S511: Acquire corresponding fields from the management background according to a data acquiring instruction in the web page access request when the web page link in the web page access request is a web page link URL of the delivery system, send the fields to the client, and perform step S516.

Step S512: Determine whether the web page link in the web page access request is an interconnecting web page link URL; and perform step S513 if yes; or perform step S514 if not.

Step S513: Acquire corresponding fields from an interconnecting shared data platform according to the data acquiring instruction in the web page access request when the web page link in the web page access request is an interconnecting web page link URL, send the fields to the client, and perform step S516.

Step S514: Determine whether the web page link in the web page access request is a web page link URL of a community platform (such as qzone), and perform step S515 if yes.

Step S515: Acquire corresponding fields from the community platform according to the data acquiring instruction in the web page access request when the web page link in the web page access request is a web page link URL of the community platform (such as qzone), send the fields to the client, and perform step S516.

Step S516: The client parses the fields when receiving the fields, assembles the parsed fields into the presentation data, and presents the presentation data.

By using the solution of this specific application example, development burdens of the client and the service background can be lowered, and development efficiency can be improved. Moreover, the solution used flexibly, and a required interface can be customized by using xml and presented.

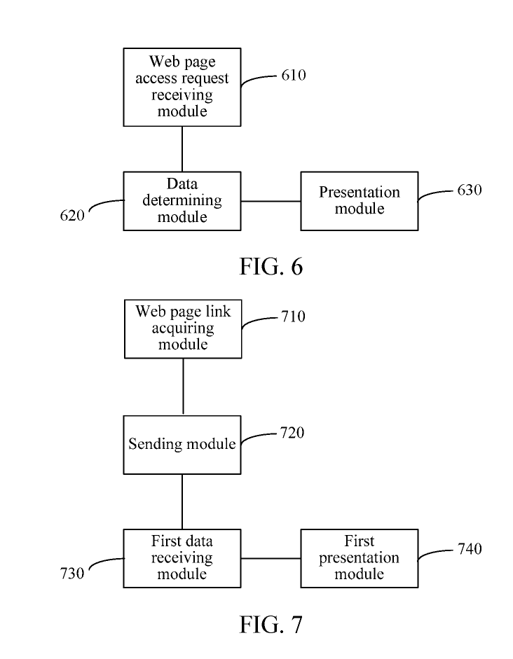

Based on the foregoing web page information presentation method, the present disclosure further provides a web page information presentation system. FIG. 6 is a schematic structural diagram of a web page information presentation system in an embodiment of the present invention. The system includes a web page access request receiving module 610, a data determining module 620, and a presentation module 630.

The web page access request receiving module 610 is configured to receive a web page access request, the web page access request being a web page access request generated according to a web page link in a dialog box of a client.

An IM tool may be a service for instant exchange of messages based on the Internet, such as QQ, WeChat, or Fetion. The dialog box may be a window used for communication, such as a chat window. When a web page link URL is sent or received in the dialog box of the client, a web page access request may be generated. The web page access request herein may be a received web page access request sent by the client, and may also be a web page access request sent by the client by using an interconnecting background.

The data determining module 620 is configured to determine web page content according to the web page access request, and assemble the web page content according to prestored layout templates to obtain laid out presentation data.

The data determining module 620 may obtain the web page content corresponding to the web page link according to the web page access request, and then assemble the web page content according to the prestored layout templates. For example, the corresponding web page content may be acquired according to a label name in the layout template, and the web page content is written under the corresponding label name, so as to obtain the laid out presentation data. The presentation data is data that needs to be presented in the dialog box, and the presented data may be data in a graphic manner and may also be xml data.

The presentation module 630 is configured to return the presentation data to the client for presentation.

The presentation module 630 sends the presentation data to the client, and directly presents the presentation data in the client.

In this embodiment, the web page access request receiving module 610 receives a web page access request of a client; the data determining module 620 determines web page content according to the web page access request, and assembles the web page content according to prestored layout templates, so as to obtain laid out presentation data; and then, the presentation module 630 returns the presentation data to the client, and directly presents the presentation data in the client, so as to avoid a processing process of assembling fields by the client and saving a processing time of the client, thereby accelerating efficiency of processing the web page information in a presentation process.

In an embodiment, sometimes, the layout templates need to be changed to present interfaces of different layouts in the dialog box. That is, the web page access request may further include a layout selection instruction.

The data determining module may further include: a layout selection module, configured to find a corresponding layout template from the prestored layout templates according to the layout selection instruction, where the number of the prestored layout templates is at least two.

In this embodiment, multiple layout templates are prestored, and one of the layout templates may be set as a default layout template. When no layout selection instruction is received, the default layout template may be used as the layout template for assembly. When the layout selection instruction is received, the corresponding layout template may be selected from the multiple layout templates.

By using the solution in this embodiment, when the template is modified, redevelopment made by the client is avoided. Instead, different layout templates are selected directly according to the layout selection instruction, thereby implementing modification of the layout templates, lowering a development burden of the client, and improving development efficiency. Meanwhile, the solution used flexibly, and a presentation interface in the dialog box can be modified at any time.

FIG. 7 is a schematic structural diagram of a web page information presentation system in another embodiment of the present invention. The system includes a web page link acquiring module 710, a sending module 720, a first data receiving module 730, and a first presentation module 740.

The web page link acquiring module 710 is configured to acquire a web page link in a dialog box of a client.

A means of acquiring the web page link may be detecting whether the dialog box of the client receives or sends the web page link; and if yes, generating a web page access request according to the web page link.

In an embodiment, the system further includes an encryption module, configured to encrypt the web page access request, so as to ensure security of the web page access request.

The sending module 720 is configured to initiate a web page access request to a service platform according to the web page link.

In an embodiment, the web page access request may be filtered. That is, the system further includes:

a detection module, configured to detect whether the web page link is a web page link in a white list, and send the web page link to the sending module if yes, where the white list records a web page link that needs to be visually presented.

This module, as a module for filtering, deletes web page link that is not in the white list and does not perform a subsequent process; and generates a web page access request only for a web page link in the white list, and sends the web page access request to the service platform, thereby improving processing efficiency.

The first data receiving module 730 is configured to receive laid out presentation data returned by the service platform, the presentation data including assembled web page content corresponding to the web page access request.

The presentation data mentioned above includes data obtained after the web page content to be presented is assembled, that is, laid out web page content. For example, the web page content may be assembled according to the prestored layout templates, so as to obtain the presentation data.

The first presentation module 740 is configured to present the presentation data in the dialog box.

After the presentation data is obtained, because the presentation data is the laid out web page content, the presentation data can be directly presented in the dialog box.

In this embodiment, the web page link acquiring module 710 acquires a web page link; and the sending module 720 initiates a web page access request to a service platform according to the web page link; the first data receiving module 730 receives laid out presentation data returned by the service platform; and the first presentation module 740 directly presents the presentation data in the dialog box, so as to avoid a processing process of assembling fields by the client and saving a processing time of the client, thereby accelerating efficiency of processing the web page information in a presentation process.

In an embodiment, the first presentation module may specifically include a presentation control creating module, a presentation control writing module, and a sub presentation module.

The presentation control creating module is configured to acquire a layout template in the presentation data; create a presentation control of the client according to the layout template; and set a name of the presentation control to be consistent with a label name in the layout template, where the layout template is a template for assembling the web page content, and the label name is a name corresponding to the web page content in the layout template.

The acquired presentation data may be data obtained by assembling the web page content according to the layout template. Therefore, the layout template may be acquired from the presentation data. The layout template records the label name and the web page content corresponding to the name, so that the presentation control of the client can be created according to the layout template.

The presentation control writing module is configured to acquire an interface pointer corresponding to the name of the presentation control by using the label name in the layout template; and write the web page content corresponding to the label name into the presentation control by using the interface pointer.

The sub presentation module is configured to present the web page content in the dialog box according to the presentation control.

In an embodiment, the client may further process unlaid out data. That is, the web page information presentation system in the present disclosure may further include:

a second data receiving module, configured to receive the unlaid out data returned by the service platform; and

a second presentation module, configured to parse the unlaid out data, assemble the unlaid out data, and present the assembled data in the dialog box.

In this embodiment, the client can not only present the laid out presentation data, but also can parse and assemble the unlaid out data to present the data in the dialog box.

The present disclosure further provides an application example. FIG. 3 is a schematic architectural diagram of implementation of the application example. The application example includes: a client 310, an interconnecting platform 320, and a service platform 330. The client 310 is separately connected to the service platform 330 by using the interconnecting platform 320.

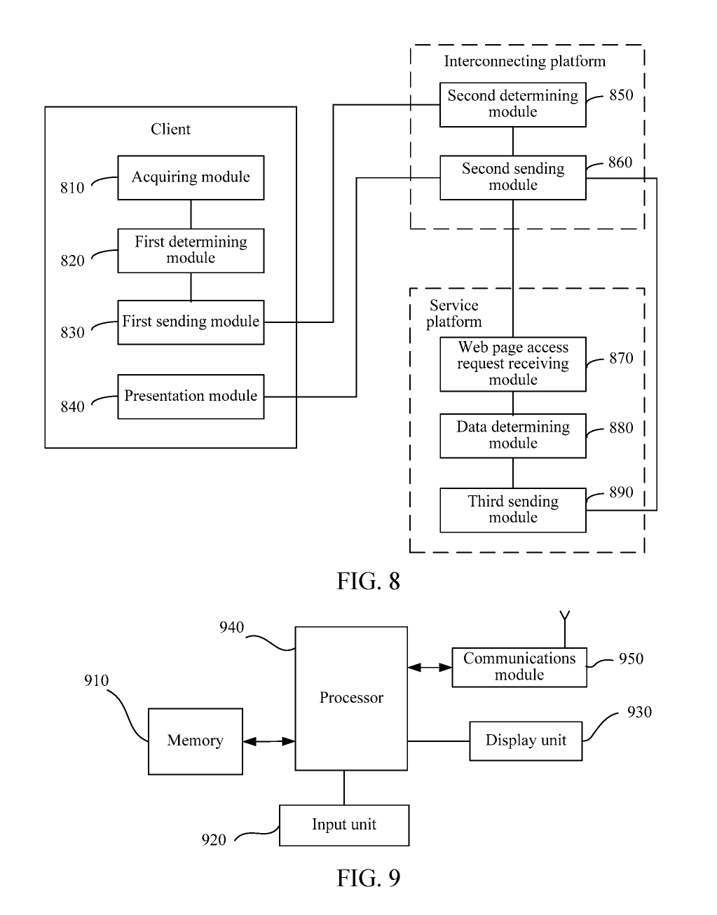

FIG. 8 is a schematic structural diagram of a web page information presentation system in an application example of the present disclosure. The system includes:

an acquiring module 810, a first determining module 820, a first sending module 830, and a presentation module 840 that are disposed on a client, where

the acquiring module 810 is configured to acquire a web page link in a dialog box of a client;

the first determining module 820 is configured to determine whether the web page link is a web page link in a white list, where the white list records a web page link that needs to be visually presented; and

the first sending module 830 is configured to initiate a web page access request to an interconnecting platform according to the web page link when the web page link is a web page link in the white list;

a second determining module 850 and a second sending module 860 that are disposed on the interconnecting platform, where

the second determining module 850 is configured to determine whether a service platform corresponding to the web page access request is a service platform in the white list, where the white list records a service platform that has an assembly function; and

the second sending module 860 is configured to send the web page access request to the service platform when the service platform is a service platform in the white list; and

a web page access request receiving module 870, a data determining module 880, and a third sending module 890 that are disposed on the service platform, where

the web page access request receiving module 870 is configured to receive the web page access request;

the data determining module 880 is configured to determine web page content according to the web page access request, and assemble the web page content according to prestored layout templates to obtain laid out presentation data;

the third sending module 890 is configured to return the presentation data to the client by using the interconnecting platform; and

the presentation module 840 is configured to present the presentation data.

A person of ordinary skill in the art may understand that all or some of the processes of the methods in the foregoing embodiments of the present invention may be implemented by a computer program instructing relevant hardware. The program may be stored in a computer readable storage medium. When the program runs, the processes of the method embodiments are performed. The storage medium may be a magnetic disk, an optical disc, a ROM, a RAM or the like. Therefore, according to the solutions in the foregoing embodiments of the present invention, the present disclosure further provides a storage medium including a computer readable program. When the computer readable program in the storage medium is executed, the web page information presentation method in the present disclosure in any one of the foregoing manners can be implemented.

The methods in the foregoing embodiments of the present invention may be installed in a corresponding machine or device in a form of software, and the process of presenting the web page information is completed by controlling a related processing device when the software is running. Correspondingly, the web page information presentation system described above may be set to be installed in a corresponding terminal device, and may also be a corresponding terminal device itself. The terminal device herein may be any terminal device such as a mobile phone, a tablet computer, a personal digital assistant (PDA), or an in-vehicle computer.

According to this, based on the solutions of the present disclosure, the present disclosure further provides a terminal device. The terminal device may be any terminal device such as a mobile phone, a tablet computer, a PDA, or an in-vehicle computer.

According to this, the following uses a terminal device as an example. FIG. 9 is a partial block structural diagram of the terminal device. Referring to FIG. 9, the terminal device includes components such as a memory 910, an input unit 920, a display unit 930, a processor 940, and a communications module 950. A person skilled in the art may understand that the structure shown in FIG. 9 is merely a partial block diagram of a structure related to the solution in this embodiment of the present invention, and does not constitute a limitation to the terminal device applied to the solution of the present disclosure. A specific terminal device may include more components or fewer components than those shown in the figure, or some components may be combined, or a different component deployment may be used.

The following specifically describes the components of the terminal device with reference to FIG. 9.

The memory 910 may be configured to store a software program and module. The processor 940 runs the software program and module stored in the memory 910, to implement various functional applications and data processing related to the terminal device. The memory 910 may mainly include a program storage area and a data storage area. The program storage area may store an operating system, an application program required by at least one function (such as a sound playback function and an image display function), and the like. The data storage area may store data created according to use of the terminal device, and the like. In addition, the memory 910 may include a high speed RAM, and may also include a non-volatile memory such as at least one magnetic disk storage device, a flash memory, or another volatile solid-state storage device.

The input unit 920 may be configured to receive input digit, character, or other information, and generate a keyboard signal input related to the user setting and function control of the terminal device. Specifically, in the solution in this embodiment of the present invention, a web page access request may be received by using the input unit 920, or presentation data may be received by using the input unit 920, or the like.

Specifically, using that the terminal device is a computer as an example, the input unit 920 may include a touch panel and another input device. The touch panel, which may also be referred to as a touch screen, may collect a touch operation of a user on or near the touch panel (such as an operation of a user on or near the touch panel by using any suitable object or accessory such as a finger or a stylus), and drive a corresponding connection apparatus according to a preset program. Optionally, the touch panel may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 940. Moreover, the touch controller can receive and execute a command sent from the processor 940. In addition, the touch panel may be a resistive, capacitive, infrared, or surface sound wave type touch panel. In addition to the touch panel, the input unit 920 may further include another input device. Specifically, the other input device may include, but is not limited to, one or more of a physical keyboard, a functional key (such as a volume control key or a switch key), a track ball, a mouse, and a joystick.

The display unit 930 may be configured to display information input by the user or information provided for the user, and various menus. The display unit 930 may include a display panel. Optionally, the display panel may be configured by using a liquid crystal display (LCD), an organic light-emitting diode (OLED), or the like.

The terminal device can implement communication with a server by using the communications module 950, where the communications module 950 may be implemented in any possible manner such as a WiFi module, Bluetooth communications, or fiber-optical communications. Communication between the terminal device and the server is implemented by using the communications module 950, thereby enabling the terminal device to send related information to the server and receive the related information returned by the server.

The processor 940 is the control center of the terminal device, and is connected to various parts of the terminal device by using various interfaces and lines. By running or executing the software program and/or module stored in the memory 910, and invoking data stored in the memory 910, the processor 940 performs various functions and data processing of the terminal device, thereby performing overall monitoring on the terminal device. Optionally, the processor 940 may include one or more processing units.

The foregoing embodiments only show several implementation manners of the present disclosure, and are described in detail, but they should not be construed as a limitation to the patent scope of the present disclosure. It should be noted that a person of ordinary skill in the art may further make variations and improvements without departing from the ideas of the present disclosure, which shall fall within the protection scope of the present disclosure. Therefore, the patent protection scope of the present disclosure should be subject to the appended claims.

What is claimed is:

1. A web page information presentation method, comprising:
at a terminal having one or more processors and a memory storing programs executed by the one or more processors;
receiving a web page access request, the web page access request being a web page access request generated according to a web page link in a dialog box of a client;
determining web page content according to the web page access request, and assembling the web page content according to prestored layout templates to obtain laid out presentation data; and
returning the presentation data to the client for presentation.

2. The web page information presentation method according to claim 1, wherein the web page access request comprises a layout selection instruction; and a corresponding layout template is found from the prestored layout templates according to the layout selection instruction, so as to assemble the web page content according to prestored layout templates to obtain the laid out presentation data.

3. A web page information presentation method, comprising:
at a terminal having one or more processors and a memory storing programs executed by the one or more processors;
acquiring a web page link in a dialog box of a client, and initiating a web page access request to a service platform according to the web page link;
receiving laid out presentation data returned by the service platform, the presentation data comprising assembled web page content corresponding to the web page access request; and
presenting the presentation data in the dialog box.

4. The web page information presentation method according to claim 3, before the step of initiating a web page access request to a service platform according to the web page link, further comprising:
detecting whether the web page link is a web page link in a white list, wherein the white list records a web page link that needs to be visually presented; and
performing, if yes, the step of initiating a web page access request to a service platform according to the web page link.

5. The web page information presentation method according to claim 3, wherein the step of presenting the presentation data in the dialog box comprises:
acquiring a layout template in the presentation data; creating a presentation control of the client according to the layout template; and setting a name of the presentation control to be consistent with a label name in the layout template, wherein the layout template is a template for assembling the web page content, and the label name is a name corresponding to the web page content in the layout template;
acquiring an interface pointer corresponding to the name of the presentation control by using the label name in the layout template; and writing the web page content corresponding to the label name into the presentation control by using the interface pointer; and
presenting the web page content in the dialog box according to the presentation control.

6. The web page information presentation method according to claim 3, wherein the method further comprises:
receiving unlaid out data returned by the service platform; and
parsing the unlaid out data, assembling the unlaid out data, and presenting the assembled data in the dialog box.

7. The web page information presentation method according to claim 3, further comprising:
encrypting the web page access request.

8. A web page information presentation system, comprising:
a processor;
a memory; and
multiple instruction modules that can be executed by the processor, the multiple instruction modules comprising:
a web page access request receiving module, configured to receive a web page access request, the web page access request being a web page access request generated according to a web page link in a dialog box of a client;
a data determining module, configured to determine web page content according to the web page access request, and assemble the web page content according to prestored layout templates to obtain laid out presentation data; and
a presentation module, configured to return the presentation data to the client for presentation.

9. The web page information presentation system according to claim 8, wherein the web page access request comprises a layout selection instruction; and
the data determining module further comprises:
a layout selection module, configured to find a corresponding layout template from the prestored layout templates according to the layout selection instruction.
